(19) United States
(12) Patent Application Publication
(10) Pub. No.: US 2025/0173778 A1
(43) Pub. Date: May 29, 2025

(54) Dynamic Market Pricing for Vehicle Trades

(71) Applicant: Vincent Loccisano, Wellesley, MA (US)

(72) Inventor: Vincent Loccisano, Wellesley, MA (US)

(21) Appl. No.: 18/520,269

(22) Filed: Nov. 27, 2023

(51) Int. Cl. G06Q 30/0645; G06Q 30/0201

(52) U.S. Cl. CPC G06Q 30/0645; G06Q 30/0206

(57) ABSTRACT

A dynamic market-pricing system enables seller-driven and buyer-driven vehicle purchases and sales in an online exchange, with prices set independently according to current market rates. The system's database matches buyers and sellers and automatically completes sales between them.

### TECHNICAL FIELD

The present disclosure relates to a distributed, computerized exchange market for dynamic, market-driven, instantaneous pricing of vehicle sales.

### BACKGROUND OF THE INVENTION

Vehicles bought and sold online currently follow static pricing, with negotiations occurring after a price has been presented by a seller or offered by a buyer. Most vehicle sales are seller-driven, in which a seller sets a price and a buyer decides whether to purchase at that price. Some vehicle sales are buyer-driven, in which buyers make offers for one or more desired vehicles, and sellers respond if they are willing to sell at the offered price. In such a system, an inquiry is proffered to a large number of potential sellers. In auctions (live and online), prices are organically determined by numerous potential buyers who bid for an item. Auctions may be open to the public or restricted to select bidders, such as licensed car dealers.

In an exchange-driven commerce system, buyers willing to buy at a particular price are matched to sellers willing to sell at that price. A stock exchange is an exchange-driven commerce system, matching buyers and sellers in a network or marketplace. Exchange-driven protocols facilitate buying and selling, favoring neither buyers nor sellers. An exchange-driven commerce system (“system”) for vehicles would enable automatic, dynamic pricing at rates determined by the current market. It would enable car-dealership trade to be conducted quickly by presenting actual as well as potential inventory, and would facilitate bulk and individual purchase through bids for desired vehicles that may not be found on a lot at a given time.

Vehicle VIN numbers reveal a vehicle's current inspection information and may define mileage as well as passed or failed inspection criteria. Cars, trucks, motorcycles, and boats have VIN numbers. One skilled in the art understands that other items such as boats, aircraft or jewelry may be identified under a similar system.

### SUMMARY OF THE INVENTION

A dynamic market-pricing system enables seller-driven and buyer-driven vehicle purchases and sales in an online exchange, with prices set independently according to current market rates. The system's database matches buyers and sellers and automatically completes sales between them.

In an example embodiment, buyers and sellers in an exchange list offers to purchase or sell a particular vehicle at a desired price. The system automatically matches sellers willing to sell at a set price to buyers willing to buy at that price, and then initiates and completes a sale. Pricing is dynamically determined by the current vehicle market, which is driven by economic factors including business climate, blue-book values, manufacturing climate, supply and demand, as well as sociological factors influencing the number of people interested in buying and selling at a given moment.

A database holds buyer, seller, geographic location and transportation-logistics information as well as price offers and bids. It is linked to Vehicle Identification Number (VIN) databases holding current vehicle condition, history and sales data. This data is pulled by the system for each set of data needed. These sets include price, VIN, location, user verification, and buyer/seller communication, among other data sets.

The exchange automatically pairs orders with appropriate offers and facilitates the purchase transaction automatically. Seller and buyer agree to details and vehicle titles and VINs are searched, reviewed and sent by the system to the appropriate parties. Taxes and loans are paid as part of the transaction and are handled within the system, which is linked to lending institutions and state transportation agencies. Shipping of the vehicle to its destination, as well as attendant pick-up and delivery logistics, are handled by the system in the sale transaction. Shipping costs are calculated by the system and added to the sale price.

The system also facilitates standing offers in which a buyer or seller places a request to buy or sell a desired vehicle at a desired price and waits until the desired vehicle becomes available. Once the vehicle enters the market and terms are agreed by buyer and seller, the order is fulfilled by the system.

In an iteration, a vehicle dealer accepting trade-ins would be able to accept a trade-in vehicle without having to house it indefinitely on a sales lot; instead the dealer would post the trade-in vehicle's particulars to the system, where it could be more easily perused and purchased in the diversified, geographically extended network of buyers. Pricing is determined by the market, unburdening the dealer of making an overly high trade-in offer to the seller. The extended nature of a geographically large market would raise the chances of buyers matching quickly with sellers who have agreed on a fair, market-driven price.

Similarly, a car dealership or an aggregator dealing in bulk sales of used cars would post their sales offerings to the system instead of having to inventory the vehicles in a physical location for sale. Pricing is determined by the market. The aggregator acts as a middleman, garnering a percentage of any facilitated sale.

Vehicle shoppers peruse the system for quotes on desired vehicles or for trade-in values. They may choose to compare going rates for their trade-in sale, or going rates for a potential purchase of someone else's trade-in, as posted by a dealership. Buyers and sellers create a profile, each of which is verified by the system. At any time, a seller who has logged in to the system may offer an item for sale (referred to as “offer”). At any time, a buyer logs on to the system and, in response to one or more of the seller's offer(s), either places an offer at the seller's posted price, or makes a counter-offer. At this point a seller may choose to accept the offer or post a revised price. The buyer is notified of this revision, and may choose to place a revised (counter) offer, or accept the revised price. This communication continues until the offer price matches the desired purchase price.

### BRIEF DESCRIPTION OF DRAWINGS

FIG. 1 is a diagram of the method of the disclosure.

### DETAILED DESCRIPTION

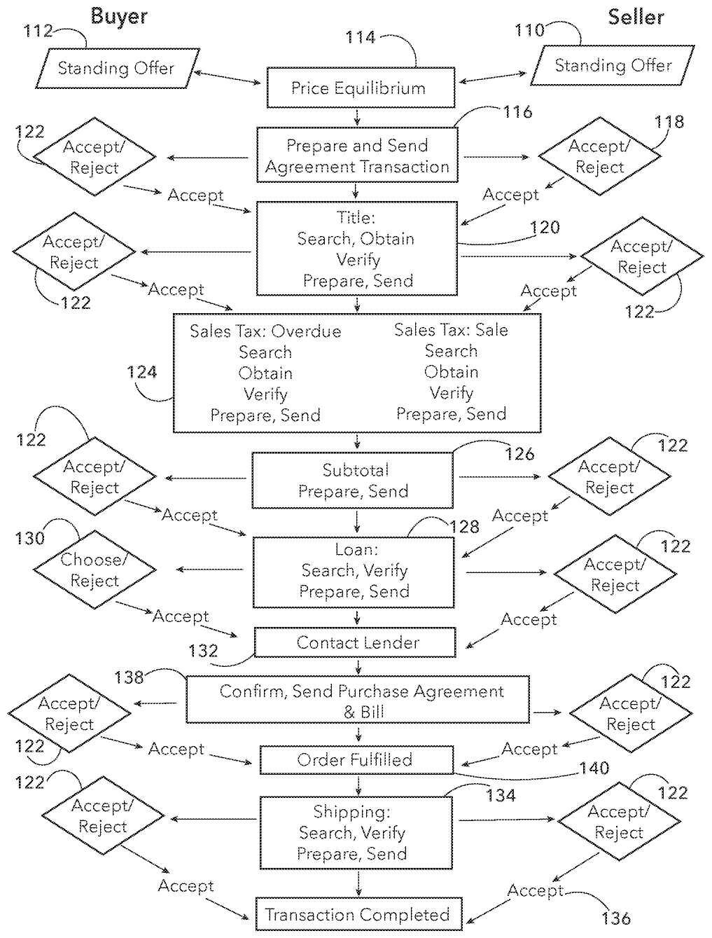

FIG. 1 shows a diagram of the distributed, distributed, computerized exchange market (hereafter known as “system”). Once an offer price 110 matches a purchase price 112, a transaction reaches equilibrium 114. Here the system initiates an agreement transaction 116 which is then sent to both buyer 112 and seller 110. The system notifies both parties, and if the offer is accepted 118 by both, the system proceeds to search, obtain, verify, and communicate transfer information 120 to each party for acceptance 122 or rejection. One skilled in the art understands that transfer information may include title information or any information or documents required for the transfer of a vehicle. One skilled in the art understands that rejection at any point in the system flow ceases the operation and asks both parties to resume or abort the transaction. One skilled in the art understands also that acceptance at any point in the flow continues to the next event. In some embodiments, acceptance or rejection may be performed manually, in which a user performs an action in the system to denote acceptance or rejection. In other embodiments, acceptance or rejection may be performed automatically according to preconfigured data. Preconfigured data may be a set of instructions chosen by one or both parties relating to their criteria for acceptance or rejection.

The system then determines sales and past-due taxes by looking up local sales-tax rates. The system calculates a local sales tax 124, adds it to the agreed price, and sends it to buyer and seller in a subtotal 126. The system then looks up vehicle-loan rates from financial databases 128 that are linked to the system, and presents these rates as a range to the buyer. Buyer chooses a rate-range-and-lender combination 130 and the choice is communicated back to the system, which contacts the lender 132 with buyer's intent to obtain vehicle financing. From there, the lending process proceeds between lender and buyer. The system proceeds to bill the buyer and process the buyer's payment 138 through standard online commerce plugins. In some embodiments a buyer may approve a loan manually by performing an action that signifies approval of the loan. In other embodiments a buyer may create preconfigured data that determines the criteria by which the buyer is willing to accept a loan, and the preconfigured data is applied by the system to automatically accept a loan that fits this data.

A verified purchase serves as a bill of sale 138. At this stage the order is deemed fulfilled 140. One skilled in the art understands that in some embodiments, one may choose to move a fulfilled order 140 to a standing offer 110, thus buying and reselling a vehicle without shipping or receiving 134.

When the buyer wishes to receive the item, the system proceeds to look up shipping services 134 local to both buyer and seller, and connects the two services as it arranges shipping. The system communicates this information 134 to buyer and seller, requesting verification from each, or corrected information from each. Once shipping logistics have been accepted 136, the transactions completes. Once skilled in the art understands that at any time during any of the transactions, buyer or seller may choose to abort the transaction, and a sale will not proceed.

1. A computer-operated method for facilitating a distributed exchange market comprising:
providing at least one seller, offering an item for sale at a given price; and
providing at least one buyer, offering to purchase said item at said given price; and
matching said at least one offer to sell with an equivalent said at least one offer to purchase; and
notifying said buyer and said seller for acceptance or rejection; and
searching, obtaining, verifying and communicating transfer information to each party upon acceptance; and
billing said buyer for said given price; and
fulfilling said exchange.

2. The method of claim 1 wherein:
searching, obtaining, verifying and communicating transfer information to each party is performed upon automatic acceptance according to a set of preconfigured data.

3. The method of claim 1 wherein:
searching, obtaining, verifying and communicating transfer information to each party is performed upon acceptance according to manual acceptance by at least one party.

4. The method of claim 1 further comprising:
calculating sales tax is performed prior to billing said buyer for said given price;
wherein
said sales tax is added to said billing.

5. The method of claim 1 further comprising:
contacting lender upon buyer's approval.

6. The method of claim 1 further comprising:
managing lending process.

7. The method of claim 1 further comprising:
searching shipping services.

8. The method of claim 1 further comprising:
offering shipping options to said buyer.

9. The method of claim 1 further comprising:
arranging chosen shipping option.

10. The method of claim 1 further comprising:
requesting verification from said buyer and said seller prior to fulfilling said exchange.

11. The method of claim 1 wherein:
upon fulfilling said exchange, said at least one buyer offers said item for sale at a given price.

12. The method of claim 1 further wherein:
searching loan rates from a linked financial database.

13. The method of claim 1 further comprising:
offering said loan rates to said buyer for approval.

14. The method of claim 12 wherein:
said linked financial database is an internal loan database.

15. The method of claim 13 wherein:
loan rates offered to said buyer are sent to an automatic approval function that approves according to preconfigured data.

16. The method of claim 13 wherein:
loan rates offered to said buyer are manually approved by said buyer.
